(19) United States
(12) Patent Application Publication
(10) Pub. No.: US 2025/0322264 A1
(43) Pub. Date: Oct. 16, 2025

(54) PRIVACY PRESERVING TABULAR LARGE LANGUAGE MODEL

(71) Applicants: Lemon Inc., Grand Caymon (KY); Beijing Zitiao Network Technology Co., Ltd., Beijing (CN)

(72) Inventors: Jiameng PU, Culver City, CA (US); Jian DU, Culver City, CA (US); Qiang YAN, Shanghai (CN)

(21) Appl. No.: 18/663,200

(22) Filed: May 14, 2024

Related U.S. Application Data
(63) Continuation of application No. PCT/CN2024/087342, filed on Apr. 11, 2024.

(51) Int. Cl. G06N 5/022

(52) U.S. Cl. CPC G06N 5/022

(57) ABSTRACT

This specification relates to privacy-preserving model training on tabular data. In some aspects, a method includes receiving, by one or more computing devices, tabular data; serializing the tabular data into a natural language string in a natural language format; combining the natural language string and a prompt as an input to a pretrained large language model (LLM) to generate a predicted result, wherein a set of learned vectors are added into the pretrained LLM for fine-tuning the pre-trained LLM; fine-tuning the pretrained LLM using a differential privacy stochastic gradient descent (SGD) process, wherein fine-tuning the pretrained LLM comprises: determining values of the learned vectors that minimize a difference between the predicted result and the ground truth; receiving a request including test tabular data for a predication task; and generating, in response to the request for the prediction task, a prediction result for the test tabular data using the fine-tuned LLM.

### CLAIM OF PRIORITY

This application claims priority under 35 USC § 120 to the Patent Cooperation Treaty Serial No. PCT/CN2024/087342, filed on Apr. 11, 2024, the entire contents of which are hereby incorporated by reference.

### TECHNICAL FIELD

This specification generally relates to security and privacy of tabular data in large language model.

### BACKGROUND

Tabular data is structured data that can encapsulate multiple characteristics about data items, for example, each data item can be represented by a row of the tabular data where multiple columns each represent a particular characteristic of the corresponding data item. For example, tabular data can encapsulate characteristics about particular users of a service, e.g., as user profiles. The use of tabular data is prevalent in many scenarios such as advertising, search engines, and recommendation systems.

Machine learning models are used for various different tasks in a wide variety of domains. Machine learning models are trained to generate particular predictions, which can relate to various tasks including generating recommendations, classifying data, making decisions, identifying patterns, and optimizing processes. Some machine learning models are considered deep learning models including large language models (LLMs).

Further, privacy compliance in the development of machine learning models is of vital importance to many organizations. Training data is particularly deemed as an important asset as well as vulnerable point of entry by malicious actors. However, privacy-preserving model training and inference can introduce significant overhead and thus impact the performance of the machine learning models, making the machine learning models less viable in applications where high performance is paramount.

### SUMMARY

The technologies described in this document provide a privacy-preserving fine-tuning process of large language models (LLMs) on tabular data. The described technologies leverage a pretrained LLM and fine-tune it on natural language description of tabular data under the rigorous definition of differential privacy. More specifically, the technologies described in this document can serialize tabular data samples into natural language strings that are consumable by the LLM. Further, the described technologies can fine-tune a pretrained LLM using domain specific training data. In the fine-tuning process, the described technologies can add or update as few parameters as possible to the pre-trained LLM. Moreover, the described technologies can incorporate differential privacy stochastic gradient descent (PD-SGD) algorithm in the fine-tuning process. The DP-SGD modifies the stochastic gradient descent process by adding carefully calibrated noise into gradients.

In one aspect, this document describes a method for privacy-preserving model training on tabular data. The method includes receiving, by one or more computing devices, tabular data; serializing the tabular data into a natural language string in a natural language format; combining the natural language string and a prompt as an input to a pretrained large language model (LLM) to generate a predicted result, wherein a set of learned vectors are added into the pretrained LLM for fine-tuning the pre-trained LLM; fine-tuning the pretrained LLM using a differential privacy stochastic gradient descent (SGD) process, wherein fine-tuning the pretrained LLM comprises: determining values of the learned vectors that minimize a difference between the predicted result and the ground truth; receiving a request including test tabular data for a predication task; and generating, in response to the request for the prediction task, a prediction result for the test tabular data using the fine-tuned LLM.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, fine-tuning the pretrained LLM includes: converting a function of each learned vector into a linear function; determining a loss function with respect to the learned vector using the linear function of the learned vector; and determining the values of the learned vector that minimize the loss function in an iterative stochastic gradient descent process with differential privacy.

In some implementations, the iterative stochastic gradient descent process with differential privacy includes: determining a gradient for the loss function; obtaining a masked gradient by adding noise into the gradient; and determining the values of the learned vectors based on the masked gradient, wherein the iterative stochastic gradient descent process is terminated if the values of the learned vectors minimize the loss function.

In some implementations, the method further includes determining an amount of the noise to add to the gradient based on noise budget parameters, wherein the noise budget parameters comprise a privacy loss parameter and a leakage probability parameter.

In some implementations, adding noise to the gradient includes: clipping the gradient based on a clipping threshold; and adding the noise into the clipped gradient to obtain the masked gradient.

In some implementations, converting a function of each learned vector into a linear function includes: converting an element-wise multiplication into a linear function. In some implementations, converting the element-wise multiplication includes: converting the learned vector into a diagonal matrix.

In some implementations, the tabular data corresponds to user profile data for a social media platform and wherein the prediction results include a recommendation of content to provide to the user.

Particular implementations of the subject matter described in this specification can be implemented so as to realize one or more of the following advantages. The technologies described in this document leverage a pretrained large language model (LLM) and fine-tune it on natural language description of tabular data while reducing the risk of leaking the privacy of training data with differential privacy. More specifically, the technologies described in this document can serialize tabular data samples into natural language strings that are consumable by the LLM. This can exploit the capability of LLM to extract valuable insight and meaningful patterns from tabular data.

Further, the described technologies can incorporate differential privacy stochastic gradient descent (PD-SGD) algorithm to fine-tune the pretrained LLM on the natural language strings. In the fine-tuning process, instead of training a new LLM from beginning, the technologies described herein add or update as few parameters as possible to a pretrained LLM. The fine-tuning process can fine-tune the pretrained LLM using domain specific training data. This can offer benefits such as improved performance, faster training, task-specific adaption, customization, reduced data requirements, etc. In addition, the PD-SGD is applied to the fine-tuning process. The DP-SGD modifies the stochastic gradient descent process in the back propagation by adding noise to gradients, and therefore the DP-SGD reduces the ability of leaking sensitive information in the training data into the trained model. In this way, the described technologies can apply LLM to tabular data while providing a specified degree of differential privacy without degrading model performance.

It is appreciated that methods and systems in accordance with the present description can include various combination of the aspects and features described herein. That is, methods and systems in accordance with the present description are not limited to the specific combinations of aspects and features specifically described herein, but also may include other combination of the aspects and features provided.

The details of one or more implementations of the present description are set forth in the accompanying drawings and the description below. Other features and advantages of the present description will be apparent from the description and drawings, and from the claims.

### BRIEF DESCRIPTION OF DRAWINGS

FIG. 1 is an example environment for privacy-preserving model training on tabular data.

FIG. 2 is a block diagram of an example process for privacy-preserving model training on tabular data.

FIG. 3 is a flow diagram of an example process for privacy-preserving model training on tabular data.

FIG. 4 is a flow diagram of an example process for fine-tuning the pretrained LLM with an iterative differential privacy SGD process.

FIG. 5 illustrates block diagrams of example computing devices.

### DETAILED DESCRIPTION

Large Language Models (LLMs) are a class of machine learning models designed to understand and generate human-like text based on vast amounts of data. These models are built using deep learning techniques, particularly variants of recurrent neural networks (RNNs) or transformer architectures. Large Language Models are used for various natural language processing tasks, including text generation, translation, summarization, sentiment analysis, question answering, and more. They have demonstrated remarkable capabilities in understanding and generating human-like text, leading to their widespread adoption in applications such as chatbots, virtual assistants, content creation, and language understanding tasks.

Differential privacy is a technique to reduce the probability of determining individualized private information from multiparty computation results without changing the outcome of the function being computed. Typically, this is done by introducing noise to individual data based on some distribution so that there is plausible deniability as to its accuracy, so that no individualized determinations can be made. However, because the distribution of the noise is known, it can be compensated for in the aggregate so that a correct final output is generated.

This document described technologies for privacy-preserving fine-tuning of large language models (LLMs) on tabular data. The technologies use a pre-trained LLM, refining it through a fine-tuning process based on natural language descriptions of tabular data. Specifically, the technologies include converting tabular data into natural language strings that can be interpreted by the LLM. Additionally, the technologies enable the fine-tuning of a pre-trained LLM with domain-specific training data, aiming to minimize the adjustment of parameters during this process. Furthermore, the technologies incorporate the differential privacy stochastic gradient descent (DP-SGD) algorithm, which introduces carefully controlled noise into gradients in the stochastic gradient descent process to preserve privacy.

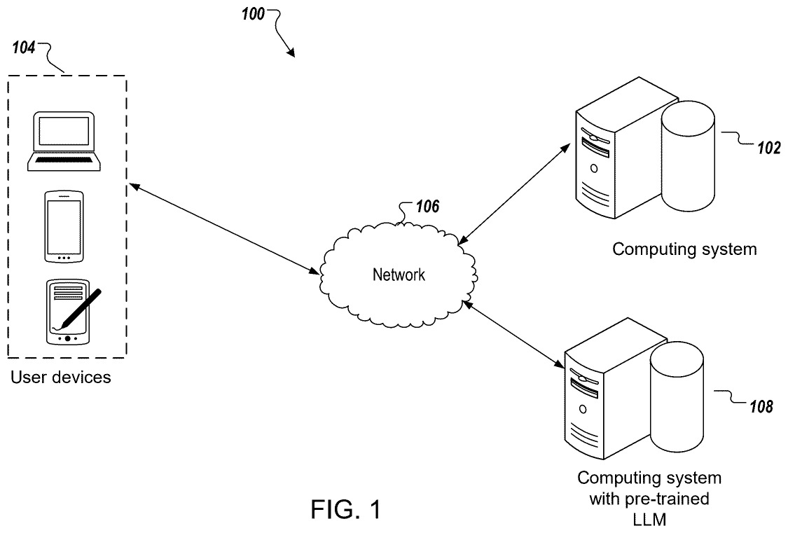

FIG. 1 is a block diagram of an example environment 100 for privacy-preserving model training on tabular data. The example environment 100 includes a computing system 102 including one or more computing devices, a set of user devices 104, a network 106, and a third-party system. The network 106 can include a local area network (“LAN”), wide area network (“WAN”), the Internet, or a combination thereof.

The set of user devices 104 can be any Internet-connected computing device, e.g., a laptop or desktop computer, a smartphone, or an electronic tablet. The user device can be connected to the Internet through a mobile network, through an Internet service provider (ISP), or otherwise. Each user device 104 is configured with software, which will be referred to as a client or as client software, that in operation can access the platform of the computing system 102. For example, the platform of the computing system 102 may provide a particular service, for example, a social networking service. In such an example, the user of the user device can post content, e.g., short form videos, and view and interact with content provided by other users, e.g., in one or more short form video streams or feeds.

The computing system 102 can interact with the set of user devices 104 and obtain user information from the set of user devices 104, for example, when the user of the user device signs up for the service provided by the computing system 102 or when the user provides particular profile information. The computing system 102 can further obtain user information through the user's interactions with the service. The computing system 102 can store the user information in a database associated with the computing system 102. The user information can be saved in one or more tables as tabular data. The tabular data can contain sensitive information associated with individual users including, for example, demographic data and behavior data associated with user interactions and other behavior on when using the service.

The computing system 102 can use the tabular data as training data to train an artificial intelligence model, such as a large language model (LLM). Using the trained LLM, the computing system can perform prediction tasks on new tabular data. For example, the computing system 102 can use a user's tabular data to predict the user's interests, needs and other behavior trend. In some examples, the computing system 102 can generate personalized recommendations for content that is likely to be of interest to individual users, for example, generating recommendations of short form videos including sponsored videos to provide, generating recommendations of other users to engage with, or generating recommendations of suggested topics.

Instead of training a LLM from the beginning, the computing system 102 uses a pretrained LLM model for task-specific predictions. For example, the pretrained LLM can be fine-tuned or adapted to specific downstream tasks, such as recommendation generation, text generation, summarization, translation, or question answering. Fine-tuning involves further training the pretrained LLM on a smaller, task-specific dataset to optimize its performance for the intended application.

The pretrained LLM can be a large language model trained by a third-party system 108. The third-party system 108 can include one or more computing devices, such as one or more servers or multiple distributed computing devices. The pretrained LLM can be trained on a massive amounts of text data to understand and generate human-like text. These models have been used for various NLP tasks, including text generation, translation, summarization, and question answering. They are capable of understanding context, syntax, and semantics in human language and generating coherent and contextually relevant responses to given prompts. In some implementations, the pretraining process involves exposing the model to a wide range of language patterns and contexts, allowing it to learn the nuances of syntax, semantics, and grammar. Through self-supervised learning tasks like language modeling and next-word prediction, the LLM model learns to generate coherent and contextually relevant text responses to given prompts.

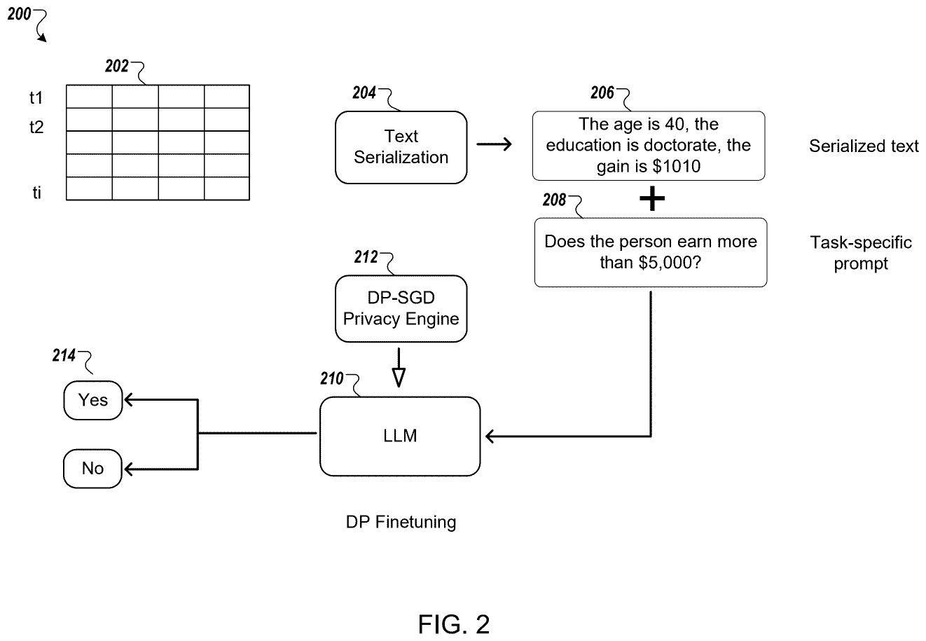

To fully exploit the capability of LLM, the computing system 102 serializes the tabular data into natural language strings. The computing system 102 then uses the natural language strings as training data for fine-tuning the pretrained LLM. The computing system performs fine-tuning on the pretrained LLM using a differential privacy stochastic gradient descent (DP-SGD) process. FIGS. 2-4 and associated descriptions provide additional details of these implementations. The parameter efficient fine-tuning process adds or updates as few parameters as possible to avoid incurring storage and memory cost. Further, the differential privacy SGD (DP-SGD) adds noise to gradients in the SGD process, and therefore reducing the risk of leaking the privacy of the training data that includes the sensitive user information.

The computing system 102 can include one or more computing devices, such as one or more servers or multiple distributed computing devices. In some implementations, the number of computing devices may be scaled (e.g., increased or decreased) automatically as per the computation resources needed. In some implementations, the computing system 102 can implement cloud-based resources where the number of virtual machines commissioned depend on the required computational resource. The various functional components of the computing system 102 may be installed on one or more computers as separate functional components or as different modules of a same functional component. For example, the various components of the computing system 102 can be implemented as computer programs installed on one or more computers in one or more locations that are coupled to each through a network. In cloud-based systems, for example, these components can be implemented by individual computing nodes of a distributed computing system.

FIG. 2 shows block diagram of an example process 200 for privacy-preserving model training on tabular data. For convenience, the process 200 will be described as being performed by a system of one or more computers, located in one or more locations, and programmed appropriately in accordance with this specification. For example, a computing system, e.g., the computing system 102 of FIG. 1, appropriately programmed, can perform the process 200.

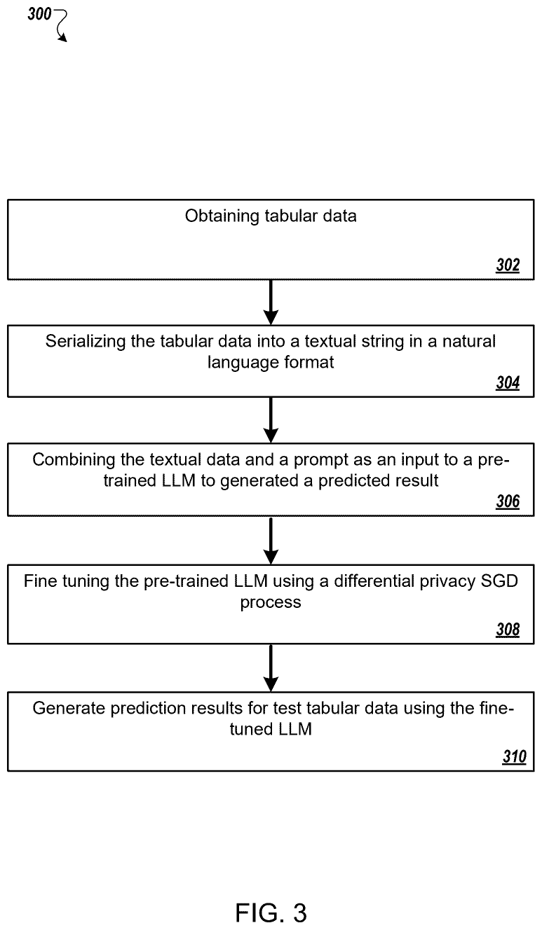

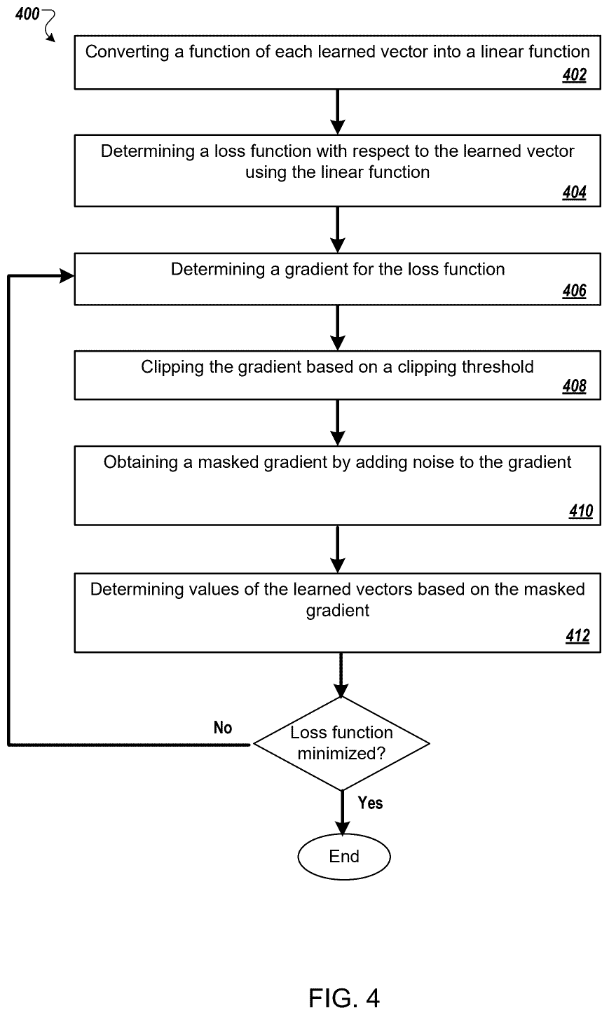

The computing system can obtain tabular data 202. The tabular data can be a table including multiple columns as features/attributes of a user. For example, the columns can be “age” “education” “gain” of users. Each row can represent a user with specific values corresponding to the columns. The computing system can perform text serialization 204 on the tabular data to obtain a natural language string 206. The computing system combines the natural language string 206 with a task-specific prompt 208 to generate as an input to a pretrained LLM 210. The pretrained LLM 210 can generate a predicted result 214, such as a classification for the prompt. To minimize a difference between the predicted result and a ground truth, the pretrained LLM 210 is fine-tuned using a differential privacy stochastic gradient descent (DP-SGD) engine 212. FIGS. 3-4 and associated descriptions provide additional details of these implementations.

FIG. 3 is a flow diagram of an example process 300 for privacy-preserving model training on tabular data. For convenience, the process 300 will be described as being performed by a system of one or more computers, located in one or more locations, and programmed appropriately in accordance with this specification. For example, a computing system, e.g., the computing system 102 of FIG. 1, appropriately programmed, can perform the process 300.

At step 302, the computing system obtains tabular data.

The tabular data can be a table containing users' sensitive information, such as demographic and behavior data. The tabular data can include a user profile dataset with n rows and d columns. The user profile dataset can be a table with d columns including various characteristics of the user profile, such as age, education, location, etc. The column names are the features or attributes indicating the characteristics of the user. Each row can be the user profile of an individual user, including the specific values of the characteristics for the user. Each row can be a d-dimensional feature vector for a user. In some embodiments, the tabular data corresponds to user profile data for a social media platform. In addition to the tabular data of user profile dataset, the training data can further include a label or a classification for each user profile. A classification of a user indicates a ground truth. For example, one classification can indicate whether the user is interested in a particular topic. Because the training data include sensitive user information, the described technologies use the training data to fine-tune the pre-trained LLM while preserving the privacy of the training data.

At step 304, the computing system serializes the tabular data as a natural language string.

During the serialization, the computing system uses the column names and feature value for each column to create a natural language string of the tabular data in each row. The natural language string is consumable by LLMs. By serialization, the tabular data can be converted into natural language strings that can be consumed by LLMs. Thus, the serialization of tabular data can exploit the capability of LLMs.

In some implementations, the computing system can serialize the tabular data with a text template. The text template can include a textual enumeration of all features included in the table, with each feature being represented as “The column name is value.” the natural language string can be generated by filling in the “column name” and “value” using the data from the tabular data. For example, the table may include a column “age” and a column “education,” and a row with corresponding values “40” and “doctorate.” The natural language string generated with the text template can be “the age is 40, the education is doctorate.”

At step 306, the computing system combines the natural language string of the tabular data and a prompt as input to a pretrained LLM to generate a predicted result. The pretrained LLM includes a set of learned vectors that are injected into the pretrained LLM for fine-tuning. In some implementations, the initial values of the learned vectors are set as 1. The values of the learned vectors are iteratively updated in the fine-tuning process.

The prompt can be a task-specific prompt that corresponds to a particular ground truth classification. For example, a task-specific prompt can be a short description of the classification problem, such as “does this person earn more than $5,000 a month?” The corresponding ground truth classification can be “yes” or “no” in response to the prompt. The training data include the ground truth classification for the prompt.

In some implementations, the pretrained LLM can be a language model that has been trained by a third-party system. The pretrained LLM can be artificial intelligence models trained on a large corpus of text data to understand and generate human-like text. Such models are capable of understanding context, syntax, and semantics in natural language and generating coherent and contextually relevant responses to given prompts.

Once pretrained, the LLM can be fine-tuned or adapted to specific tasks. Fine-tuning involves further training the LLM on a smaller, task-specific dataset to optimize its performance for the intended application. In some implementations, to perform parameter efficient fine-tuning on the pretrained LLM, learned vectors are added into the pretrained LLM. For example, the learned vectors are added into the attention and feedforward modules of the LLM. In some implementations, the initial values of the learned vectors are set as 1. These learned vectors are the only trainable parameters during fine-tuning. The parameter efficient fine-tuning adds or updates as few parameters as possible to avoid incurring storage and memory cost.

The pretrained LLM uses the input to generate a predicted result. The predicted result may be accurate or inaccurate. For example, the predicted result may be consistent or inconsistent with the ground truth.

At step 308, the computing system fine-tunes the pretrained LLM using a differential privacy stochastic gradient descent (DP-SGD) process.

During the fine-tuning process, the LLM is further trained to become more accurate for the task-specific application. In the fine-tuning process, the LLM uses the feature vector of a user to predict a result. The predicted result is compared with the ground truth to determine a loss value based on a loss function. The loss value represents a difference between the predicted result and the ground truth. In the fine-tuning process, the values of the learned vector parameters are determined to minimize the loss value.

In general, the fine-tuning process is iteratively performed, where, during an iteration, one or more parameters of the learned vector are adjusted, and an output is generated based on the training data. For each iteration, the loss value is determined based on the loss function. The loss value represents a degree of accuracy of the output of the LLM. The loss value can be described as a representation of a degree of difference between the output of the LLM and an expected output of the LLM (the expected output, e.g., ground truth being provided from training data). In some examples, if the loss value does not meet an expected value (e.g., is not equal to zero), parameters of the learned vectors are adjusted in another iteration of fine-tuning. In some instances, this process is repeated until the loss value meets the expected value.

In the fine-tuning process, the values of the learned vectors are determined using the differential privacy SGD process. As a result, the computing system outputs a fine-tuned LLM. FIG. 4 shows the steps of the fine-tuning process where the values of the learned vectors are determined in an iterative differential privacy SGD process.

At step 310, the computing system generates prediction results for test tabular data using the fine-tuned LLM. Specifically, the computing system can receive a request including test tabular data for a prediction task and a test prompt for the prediction task. The computing system serializes the test tabular data as a test natural language string, and combines the test natural language string and the test prompt as input to the fine-tuned differential privacy LLM, which can generate a prediction result in response to the request for the prediction task. In some implementations, the fine-tuned differential privacy LLM can output multiple options with each option corresponding to a probability. The prediction result can be the option with the largest probability. In some implementations, the prediction result includes a recommendation of content to provide to the user.

The order of steps in the process 300 described above is illustrative only, and the process 300 can be performed in different orders. In some implementations, the process 300 can include additional steps, fewer steps, or some of the steps can be divided into multiple steps.

FIG. 4 is a flow diagram of an example process 400 for fine-tuning the pretrained LLM with an iterative differential privacy SGD process in accordance with technology described herein. For convenience, the process 400 will be described as being performed by a system of one or more computers, located in one or more locations, and programmed appropriately in accordance with this specification. For example, a computing system, e.g., the computing system 102 of FIG. 1, appropriately programmed, can perform the process 400.

At step 402, the computing system converts a function of each learned vector into a linear function.

As discussed above, the learned vectors are added into the pretrained LLM. The learned vectors can rescale the keys and values in attention mechanisms and the inner activations in position-wise feed-forward network of the LLM. For example, the learned vectors lₖ, lᵥ are introduced into the attention mechanisms as:

$$Softmax \frac{Q ( {l}_{k} ⊙ {K}^{T} )}{\sqrt{{d}_{k}}} ( {l}_{v} ⊙ V )$$

The learned vectors lₖ, lᵥ are added in element-wise multiplication denoted as ⊙. The initial values of the learned vectors can be set as 1. The parameters K^{T}, dₖ, and V can be determined based on input feature vectors.

To determine the values of the learned vectors, the computer system can apply the SGD process. Because the SGD process is for linear computation, the computer system first converts the element-wise multiplication into a linear computation. More specifically, the computing system converts each learned vector into a diagonal matrix. Each element of the learned vector is mapped into a corresponding diagonal element in the matrix. For example, each element of the vector lᵢ becomes the (i, i)-th element of the diagonal matrix. The other elements in the matrix are set as 0.

At step 404, the computing system determines a loss function with respect to the learned vector using the linear function.

After converting the function of each learned vector into a linear function, the computing system can determine a loss function with respect to the learned vector using the linear function of the learned vector. The computing system can determine the values of the learned vector that minimize the loss function in an iterative SGD process with differential privacy. The SGD process is an optimization algorithm often used in machine learning applications to find the model parameters that correspond to the best fit between predicted and actual outputs.

Specifically, the computer system can use the combination of the natural language string, e.g., serialized tabular data, and the task-specific prompt as input to the pretrained LLM that is to be fine-tuned using the learned vectors. The computer system can generate a predicted output based on the input. The computer system can determine the loss value based on the predicted output and the ground truth. The computer system can adjust the values of the learned vectors in a back propagation process to minimize the loss value of the loss function. In the adjusting process, the SGD algorithm is applied.

At step 406, the computing system determines a gradient for the loss function.

As discussed above, during the back propagation, the computer system can apply the SGD algorithm to determine the values of the learned vectors. The SGD is an iterative optimization process that searches for the optimal values of the learned vectors to minimize the loss function. In each iteration, a gradient is calculated for the loss function. The values of the learned vectors can be determined based on the gradient. This iterative process of the SGD can be terminated when the optimal values of the learned vectors are found, e.g., the optimal values of the learned vectors minimize the loss function.

However, the gradient in existing technologies could reveal the privacy of the training data. For example, assuming there are two tabular datasets as neighboring datasets if they differ by a single entry (e.g., one individual's data), the gradient in the training process of LLM can be influenced by the single entry. For example, the gradient of the LLM using the dataset including the single entry can be significantly different from (e.g., larger than) the gradient of LLM using the dataset without the single entry. Because the influence of the single entry can be reflected on the gradient of the LLM, the private data of the single entry can be inferred from the gradient, e.g., by comparing the gradients derived from the two neighboring datasets.

At step 408, the computing system can clip the gradient based on a clipping threshold.

In order to preserve the privacy of the training data, the computer system can apply differential privacy SGD (DP-SGD) during the back propagation. The DP-SGD can modify the stochastic gradient descent process by clipping the gradient and adding carefully calibrated noise into the gradient.

For example, the gradient g can be replaced by

$$g / max ( 1 , \frac{{‖ g ‖}_{2}}{C} )$$

based on a clipping threshold C. The clipping can ensure that if ∥g∥₂≤C, the gradient is preserved. If ∥g∥₂>C, the gradient is scaled down to be of norm C, where ∥g∥₂ is the 2-norm of g, e.g., the distance of the vector coordinate from the origin of the vector space As discussed above, the single entry can result in a larger gradient. By clipping the gradient, the influence of the single entry can be reduced.

At step 410, the computing system adds noise into the gradient to obtain a masked gradient.

The privacy of individuals' information in the training data can be protected in a specific level by differential privacy. In general, differential privacy reduces the risk of privacy leakage when a person or entity tries to learn sensitive information about individuals from the output of data analysis. Differential privacy can add calibrated noise for privacy protection, e.g., adding enough noise to the output to mask the contribution of any possible individual in the data while still preserving the overall accuracy of the analysis.

Differential privacy is used to add random noise to the gradient to make it more difficult to learn about a single entry (e.g., an individual's data) from the gradients derived from the two sets of tabular data. As discussed above, the gradient may be clipped based on a clipping threshold, e.g., when ∥g∥₂>C. If the gradient is clipped, the random noise is added to the clipped gradient; otherwise, the random noise is added to the preserved gradient.

The amount of noise can be determined by privacy budget parameters including a privacy loss parameter ∈ and a leakage probability parameter δ. The privacy budget parameters determine the amount of noise that needs to be added to achieve a certain level of privacy.

The privacy loss parameter ∈ measures the effect of each individual's information on the output of an analysis. The privacy loss parameter ∈ is used to tune the level of privacy protection required. This choice also affects the utility or accuracy that can be obtained from analysis of two neighboring datasets. A smaller value of E results in a smaller deviation and is therefore associated with strong privacy protection but less accuracy. In some implementations, ∈ is a small number, between approximately 1/1000 and 1.

The leakage probability parameter δ controls the probability that a privacy breach event would happen and hence should be kept very small. The changes of privacy leakage might increase with the size of the database. In some implementations, the leakage probability parameter δ is less than the inverse of the size of the database.

In some implementations, the privacy budget parameters can be predetermined values. The computing system can determine the amount of the noise using the privacy budget parameters. The computing system can add the noise to the gradient to obtain a masked gradient. In this way, the described technologies can reduce the risk of leaking privacy of the training data to the LLM.

At step 412, the computing system can determine the values of the learned vectors based on the masked gradient.

If the values of the learned vectors do not minimize the loss function, the computing system can determine another gradient in the next iteration and further determine another set of values for the learned vectors. This iterative SGD process can be terminated when the determined values of the learned vectors minimize the loss function.

The order of steps in the process 400 described above is illustrative only, and the process 400 can be performed in different orders. In some implementations, the process 400 can include additional steps, fewer steps, or some of the steps can be divided into multiple steps.

Embodiments of the subject matter and the actions and operations described in this specification can be implemented in digital electronic circuitry, in tangibly-embodied computer software or firmware, in computer hardware, including the structures described in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

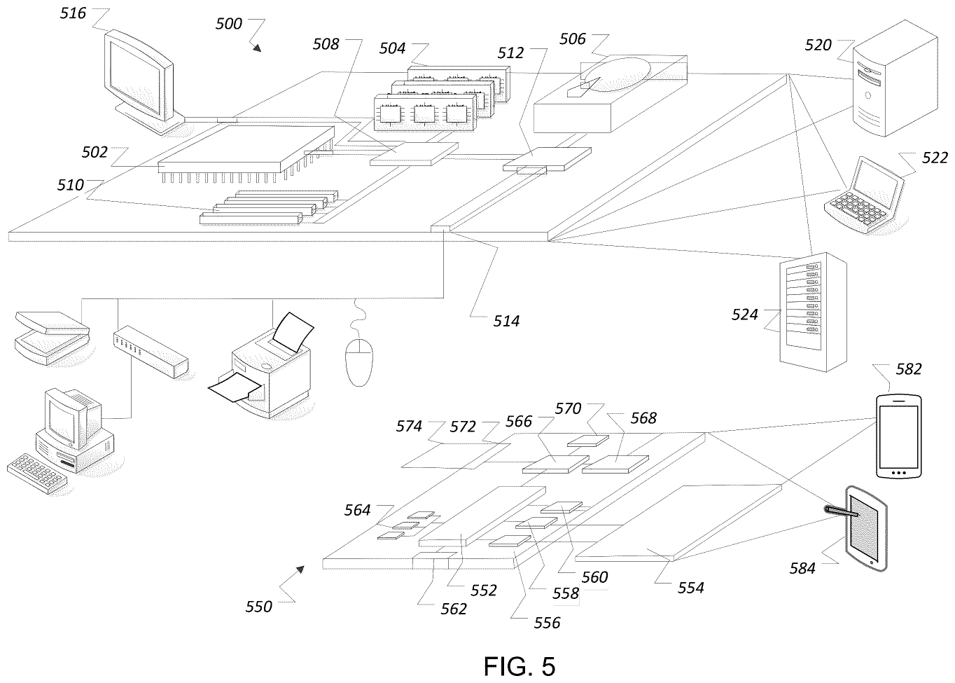

FIG. 5 shows an example of a computing device 500 and a mobile computing device 550 (also referred to herein as a wireless device) that are employed to execute implementations of the present description. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 500 can form at least a portion of the computing system 102.

The computing device 500 includes a processor 502, a memory 504, a storage device 506, a high-speed interface 508, and a low-speed interface 512. In some implementations, the high-speed interface 508 connects to the memory 504 and multiple high-speed expansion ports 510. In some implementations, the low-speed interface 512 connects to a low-speed expansion port 514 and the storage device 506. Each of the processor 502, the memory 504, the storage device 506, the high-speed interface 508, the high-speed expansion ports 510, and the low-speed interface 512, are interconnected using various buses, and may be mounted on a common motherboard or in other manners as appropriate. The processor 502 can process instructions for execution within the computing device 500, including instructions stored in the memory 504 and/or on the storage device 506 to display graphical information for a graphical user interface (GUI) on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of a computer-readable medium, such as a magnetic or optical disk.

The storage device 506 is capable of providing mass storage for the computing device 500. In some implementations, the storage device 506 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 502, perform one or more methods, such as those described above. The instructions can also be stored by one or more storage devices, such as computer-readable or machine-readable mediums, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards. In the implementation, the low-speed interface 512 is coupled to the storage device 506 and the low-speed expansion port 514. The low-speed expansion port 514, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 514 through a network adapter. Such network input/output devices may include, for example, a switch or router.

The computing device 500 may be implemented in a number of different forms, as shown in the FIG. 5. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device, such as a mobile computing device 550. Each of such devices may contain one or more of the computing device 500 and the mobile computing device 550, and an entire system may be made up of multiple computing devices communicating with each other.

The mobile computing device 550 includes a processor 552; a memory 564; an input/output device, such as a display 554; a communication interface 566; and a transceiver 568; among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate. In some implementations, the mobile computing device 550 may include a camera device(s) (not shown).

The processor 552 can execute instructions within the mobile computing device 550, including instructions stored in the memory 564. The processor 552 may be implemented as a chipset of chips that include separate and multiple analog and digital processors. For example, the processor 552 may be a Complex Instruction Set Computers (CISC) processor, a Reduced Instruction Set Computer (RISC) processor, or a Minimal Instruction Set Computer (MISC) processor. The processor 552 may provide, for example, for coordination of the other components of the mobile computing device 550, such as control of user interfaces (UIs), applications run by the mobile computing device 550, and/or wireless communication by the mobile computing device 550.

The processor 552 may communicate with a user through a control interface 558 and a display interface 556 coupled to the display 554. The display 554 may be, for example, a Thin-Film-Transistor Liquid Crystal Display (TFT) display, an Organic Light Emitting Diode (OLED) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a Single in Line Memory Module (SIMM) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 552, perform one or more methods, such as those described above. The instructions can also be stored by one or more storage devices, such as one or more computer-readable or machine-readable mediums, such as the memory 564, the expansion memory 574, or memory on the processor 552. In some implementations, the instructions can be received in a propagated signal, such as, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 568 using a radio frequency. In addition, short-range communication, such as using a Bluetooth or Wi-Fi, may occur. In addition, a Global Positioning System (GPS) receiver module 570 may provide additional navigation—and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in FIG. 5. Other implementations may include a phone device 582 and a tablet device 584. The mobile computing device 550 may also be implemented as a component of a smart-phone, personal digital assistant, AR device, or other similar mobile device.

Computing device 500 and/or 550 can also include USB flash drives. The USB flash drives may store operating systems and other applications. The USB flash drives can include input/output components, such as a wireless transmitter or USB connector that may be inserted into a USB port of another computing device.

Although a few implementations have been described in detail above, other modifications may be made without departing from the scope of the inventive concepts described herein, and, accordingly, other implementations are within the scope of the following claims.

What is claimed is:

1. A computer-implemented method comprising:
receiving, by one or more computing devices, tabular data;
serializing the tabular data into a natural language string in a natural language format;
combining the natural language string and a prompt as an input to a pretrained large language model (LLM) to generate a predicted result, wherein a set of learned vectors are added into the pretrained LLM for fine-tuning the pre-trained LLM;
fine-tuning the pretrained LLM using a differential privacy stochastic gradient descent (SGD) process, wherein fine-tuning the pretrained LLM comprises: determining values of the learned vectors that minimize a difference between the predicted result and the ground truth;
receiving a request including test tabular data for a predication task; and
generating, in response to the request for the prediction task, a prediction result for the test tabular data using the fine-tuned LLM.

2. The computer-implemented method of claim 1, wherein fine-tuning the pretrained LLM comprises:
converting a function of each learned vector into a linear function;
determining a loss function with respect to the learned vector using the linear function of the learned vector; and
determining the values of the learned vector that minimize the loss function in an iterative stochastic gradient descent process with differential privacy.

3. The computer-implemented method of claim 2, wherein the iterative stochastic gradient descent process with differential privacy comprises:
determining a gradient for the loss function;
obtaining a masked gradient by adding noise into the gradient; and
determining the values of the learned vectors based on the masked gradient,
wherein the iterative stochastic gradient descent process is terminated if the values of the learned vectors minimize the loss function.

4. The computer-implemented method of claim 3, further comprising:
determining an amount of the noise to add to the gradient based on noise budget parameters, wherein the noise budget parameters comprise a privacy loss parameter and a leakage probability parameter.

5. The computer-implemented method of claim 3, wherein adding noise to the gradient comprises:
clipping the gradient based on a clipping threshold; and
adding the noise into the clipped gradient to obtain the masked gradient.

6. The computer-implemented method of claim 2, wherein converting a function of each learned vector into a linear function comprises:
converting an element-wise multiplication into a linear function.

7. The computer-implemented method of claim 6, wherein converting the element-wise multiplication comprises:
converting the learned vector into a diagonal matrix.

8. The computer-implemented method of claim 1, the tabular data corresponds to user profile data for a social media platform and wherein the prediction results include a recommendation of content to provide to the user.

9. A non-transitory computer-readable medium encoded with instructions that, when executed by one or more computers, cause the one or more computers to perform operations comprising:
receiving tabular data;
serializing the tabular data into a natural language string in a natural language format;
combining the natural language string and a prompt as an input to a pretrained large language model (LLM) to generate a predicted result, wherein a set of learned vectors are added into the pretrained LLM for fine-tuning the pre-trained LLM;
fine-tuning the pretrained LLM using a differential privacy stochastic gradient descent (SGD) process, wherein fine-tuning the pretrained LLM comprises: determining values of the learned vectors that minimize a difference between the predicted result and the ground truth;
receiving a request including test tabular data for a predication task; and
generating, in response to the request for the prediction task, a prediction result for the test tabular data using the fine-tuned LLM.

10. The non-transitory computer-readable medium of claim 9, wherein fine-tuning the pretrained LLM comprises:
converting a function of each learned vector into a linear function;
determining a loss function with respect to the learned vector using the linear function of the learned vector; and
determining the values of the learned vector that minimize the loss function in an iterative stochastic gradient descent process with differential privacy.

11. The non-transitory computer-readable medium of claim 10, wherein the iterative stochastic gradient descent process with differential privacy comprises:
determining a gradient for the loss function;
obtaining a masked gradient by adding noise into the gradient; and
determining the values of the learned vectors based on the masked gradient,
wherein the iterative stochastic gradient descent process is terminated if the values of the learned vectors minimize the loss function.

12. The non-transitory computer-readable medium of claim 11, wherein the operations further comprise:
determining an amount of the noise to add to the gradient based on noise budget parameters, wherein the noise budget parameters comprise a privacy loss parameter and a leakage probability parameter.

13. The non-transitory computer-readable medium of claim 11, wherein adding noise to the gradient comprises:
clipping the gradient based on a clipping threshold; and
adding the noise into the clipped gradient to obtain the masked gradient.

14. The non-transitory computer-readable medium of claim 10, wherein converting a function of each learned vector into a linear function comprises:
converting an element-wise multiplication into a linear function.

15. The non-transitory computer-readable medium of claim 14, wherein converting the element-wise multiplication comprises:
converting the learned vector into a diagonal matrix.

16. The non-transitory computer-readable medium of claim 9, the tabular data corresponds to user profile data for a social media platform and wherein the prediction results include a recommendation of content to provide to the user.

17. A system comprising one or more computers and one or more storage devices on which are stored instructions that are operable, when executed by the one or more computers, to cause the one or more computers to perform operations comprising:
receiving tabular data;
serializing the tabular data into a natural language string in a natural language format;
combining the natural language string and a prompt as an input to a pretrained large language model (LLM) to generate a predicted result, wherein a set of learned vectors are added into the pretrained LLM for fine-tuning the pre-trained LLM;
fine-tuning the pretrained LLM using a differential privacy stochastic gradient descent (SGD) process, wherein fine-tuning the pretrained LLM comprises: determining values of the learned vectors that minimize a difference between the predicted result and the ground truth;
receiving a request including test tabular data for a predication task; and
generating, in response to the request for the prediction task, a prediction result for the test tabular data using the fine-tuned LLM.

18. The system of claim 17, wherein fine-tuning the pretrained LLM comprises:
converting a function of each learned vector into a linear function;
determining a loss function with respect to the learned vector using the linear function of the learned vector; and
determining the values of the learned vector that minimize the loss function in an iterative stochastic gradient descent process with differential privacy.

19. The system of claim 18, wherein the iterative stochastic gradient descent process with differential privacy comprises:
determining a gradient for the loss function;
obtaining a masked gradient by adding noise into the gradient; and
determining the values of the learned vectors based on the masked gradient,
wherein the iterative stochastic gradient descent process is terminated if the values of the learned vectors minimize the loss function.

20. The system of claim 19, wherein the operations further comprise:
determining an amount of the noise to add to the gradient based on noise budget parameters, wherein the noise budget parameters comprise a privacy loss parameter and a leakage probability parameter.
